(19) United States
(12) Patent Application Publication
(10) Pub. No.: US 2019/0019486 A1
(43) Pub. Date: Jan. 17, 2019

(54) DOORBELL DEVICE AND POWER SUPPLY METHOD THEREFOR

(71) Applicant: LG INNOTEK CO., LTD., Seoul (KR)

(72) Inventors: Ki Kyung JEON, Seoul (KR); Jung Young BAE, Seoul (KR); Min Yong CHOI, Seoul (KR)

(73) Assignee: LG INNOTEK CO., LTD., Seoul (KR)

(21) Appl. No.: 16/066,495

(22) PCT Filed: Jan. 3, 2017
(86) PCT No.: PCT/KR2017/000052

§ 371 Date: Jun. 27, 2018

(30) Foreign Application Priority Data
Jan. 4, 2016 (KR) 10-2016-0000576

(51) Int. Cl. G10K 1/064

(52) U.S. Cl. CPC G10K 1/064; G10K 15/02

(57) ABSTRACT

According to one embodiment of the present invention, a doorbell device comprises: a power input unit; an interface unit; a battery unit for supplying power to the interface unit; a switching circuit connected to a doorbell switch so as to change a path of a current supplied from the power input unit according to an on/off state of the doorbell switch; and a control unit for charging the battery unit by using a current outputted from the switching circuit, wherein the control unit performs control such that the battery unit supplies power to the interface unit if the current outputted from the switching circuit toward the control unit is cut off.

### TECHNICAL FIELD

The present invention relates to a doorbell device and a power supply method therefor.

### BACKGROUND ART

A conventional door bell system installed within a house includes a transformer, a doorbell, and a doorbell switch. The transformer converts a level of an alternating current (AC) voltage into a level thereof suitable for operating the doorbell. The doorbell is a device for outputting a sound using electromagnetism or electricity and may be interchangeably used with a bell, a buzzer, a chime, or the like. Further, the doorbell switch is a switch which is usually in an open state, and when the doorbell switch is pressed, the door bell system is activated. For example, when a person presses the doorbell switch, a closed loop for the doorbell is formed. Consequently, the doorbell may output a sound.

Meanwhile, as the desire for user convenience increases, a technique for connecting various interfaces to a doorbell system is being developed. To this end, there is an attempt for branching power, from a conventional door bell system to an interface device, to supply the power. However, in this case, there is a problem in that power is not supplied to the interface device because a closed circuit for the doorbell is formed when the doorbell switch is pressed. Further, although there is an attempt to use a battery to supply power to the interface device, there is a problem in that the interface device does not operate when the battery is discharged.

### DISCLOSURE

### Technical Problem

The present invention is directed to providing a doorbell system including an interface device.

### Technical Solution

One aspect of the present invention provides a doorbell device including a power input unit, an interface unit, a battery unit for supplying power to the interface unit, a switching circuit connected to a doorbell switch and configured to change a path of a current supplied from the power input unit according to an ON or OFF state of the doorbell switch, and a control unit for charging the battery unit using a current output from the switching circuit, wherein, when the current output from the switching circuit toward the control unit is cut off, the control unit controls the battery unit to supply power to the interface unit.

The path of the current may be a path directed from the power input unit to the control unit or may be a path directed from the power input unit to the doorbell switch.

The switching circuit may include a triac element, and when the doorbell switch is turned on, the triac element may cut off a current output to the control unit and may allow the current to flow to the doorbell switch.

The switching circuit may further include a gate element, and the gate element may transmit a driving signal to the interface unit.

The gate element may be connected to the triac element and may be operated in response to the current flowing to the doorbell switch.

The gate element may include an optocoupler.

The switching circuit may further include a rectifier, and the rectifier may rectify an alternating current (AC), which is a current received from the power input unit, into a direct current (DC) and may supply the DC current to the control unit.

The interface unit may include at least one of an audio module, an image module, a communication module, and a sensor module.

The control unit may include a converter and a battery charging chip.

Another aspect of the present invention provides a method for supplying power to doorbell device, the method including receiving, by a switching circuit, power from a power input unit, changing, by the switching circuit, a path of a current supplied from the power input unit according to an ON or OFF state of a doorbell switch, charging, by a control unit, a battery unit using a current output from the switching circuit, when the current output from the switching circuit is cut off, controlling, by the control unit, the battery unit to supply power to an interface unit, and supplying, by the battery unit, charged power to the interface unit.

### Advantageous Effects

A doorbell device according to the embodiment of the present invention can stably supply power to an interface device even when a closed circuit for a door bell is formed. Further, the doorbell device according to the embodiment of the present invention can continuously charge a battery that supplies power to the interface device.

### DESCRIPTION OF DRAWINGS

FIG. 1 is a diagram illustrating a doorbell system according to one embodiment of the present invention.

FIG. 2 is a block diagram of a doorbell device according to one embodiment of the present invention.

FIG. 3 is a block diagram of an interface unit included in the doorbell device according to one embodiment of the present invention.

FIG. 4 is a flowchart illustrating a method for supplying power to the doorbell device according to one embodiment of the present invention.

FIG. 5 is a circuit diagram included in the doorbell device according to one embodiment of the present invention.

### MODES OF THE INVENTION

The present invention may be modified into various forms and may have a variety of embodiments, and, therefore, specific embodiments will be illustrated in the drawings and described. The embodiments, however, are not to be taken in a sense which limits the present invention to the specific embodiments, and should be construed to include modifications, equivalents, or substituents within the spirit and technical scope of the present invention.

Also, the terms including ordinal numbers such as first, second, and the like used herein may be used to describe various components, but the various components are not limited by the terms. The terms are used only for the purpose of distinguishing one component from another component. For example, without departing from the scope of the present invention, a second component may be referred to as a first component, and similarly, a first component may also be referred to as a second component. The term “and/or” includes a combination of a plurality of related listed items or any one item of the plurality of related listed items.

When a component is referred to as being “connected” or “coupled” to another component, it may be directly connected or coupled to the other component, but it should be understood that another component may exist between the component and the other component. Contrarily, when a component is referred to as being “directly connected” or “directly coupled” to another component, it should be understood that the other component may be absent between the component and the other component.

The terms used herein are employed to describe only specific embodiments and are not intended to limit the present invention. Unless the context clearly dictates otherwise, the singular form includes the plural form. It should be understood that the terms “comprise,” “include,” and “have” specify the presence of stated herein features, numbers, steps, operations, components, elements, or combinations thereof, but do not preclude the presence or possibility of adding one or more other features, numbers, steps, operations, components, elements, or combinations thereof.

Unless otherwise defined, all terms including technical or scientific terms used herein have the same meaning as commonly understood by those skilled in the art to which the present invention pertains. General terms that are defined in a dictionary shall be construed as having meanings that are consistent in the context of the relevant art and are not to be interpreted as having an idealistic or excessively formalistic meaning unless clearly defined in the present application.

Hereinafter, embodiments of the present invention will be described in detail with reference to the drawings, the same reference numerals are given to the same or corresponding components regardless of a number of the drawing, and a repetitive description thereof will be omitted.

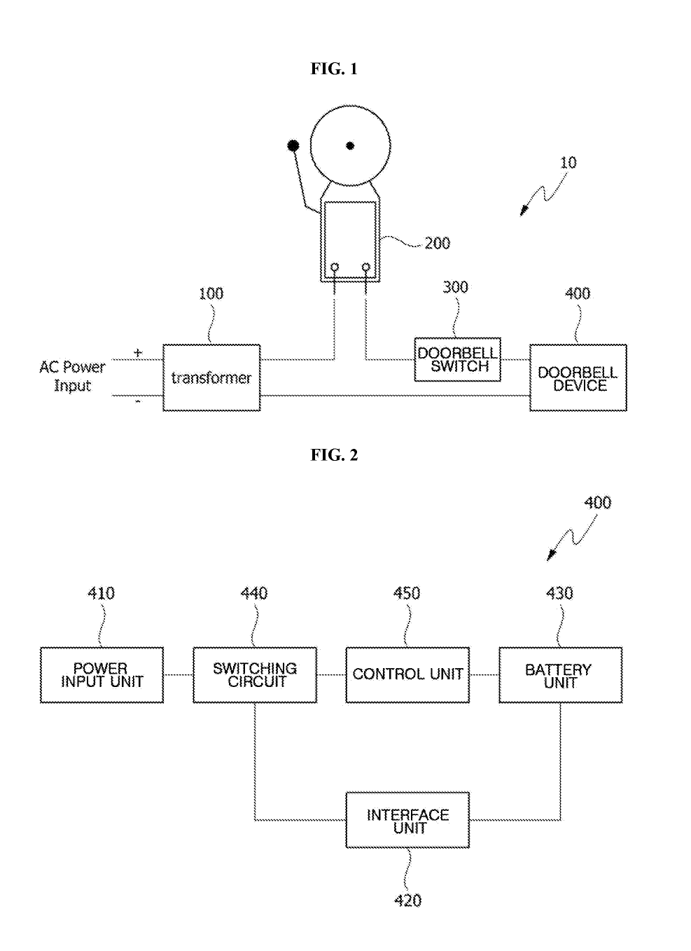

FIG. 1 is a diagram illustrating a doorbell system according to one embodiment of the present invention.

Referring to FIG. 1, a doorbell system 10 according to one embodiment of the present invention includes a transformer 100, a doorbell 200, a doorbell switch 300, and a doorbell device 400.

The transformer 100 may include a primary coil and a secondary coil. The primary coil may be connected to an alternating current (AC) power source (not shown) installed within a house, and the second coil may be sequentially connected to the doorbell 200, the doorbell switch 300, and the doorbell device 400. The transformer 100 converts a level of an AC voltage into a level thereof suitable for operating the doorbell 200. The doorbell 200 is a device for outputting a sound using electromagnetism or electricity and may be interchangeably used with a bell, a buzzer, a chime, or the like. The doorbell switch 300 is a switch which is usually in an open state, and when the doorbell switch 300 is pressed, the doorbell 200 is activated to output a sound.

Further, the doorbell device 400 according to one embodiment of the present invention may include various interfaces and may be connected to a conventional doorbell system, i.e., the transformer 100, the doorbell 200, and the doorbell switch 300. According to one embodiment of the present invention, power is stably supplied to various interface devices included in the doorbell device 400 regardless of an ON or OFF state of the doorbell switch 300.

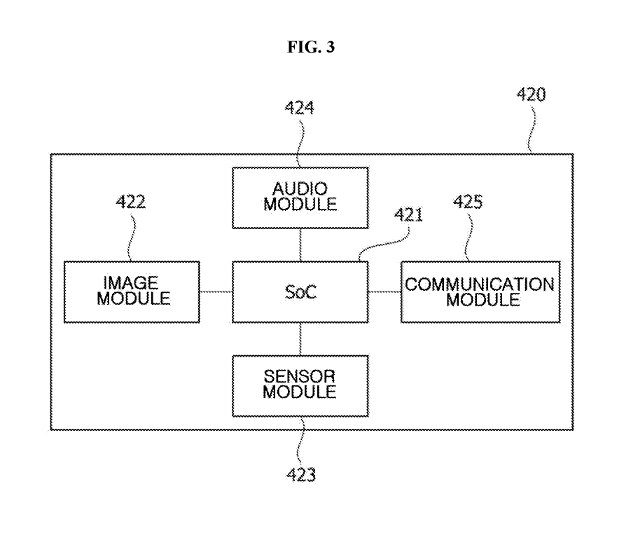

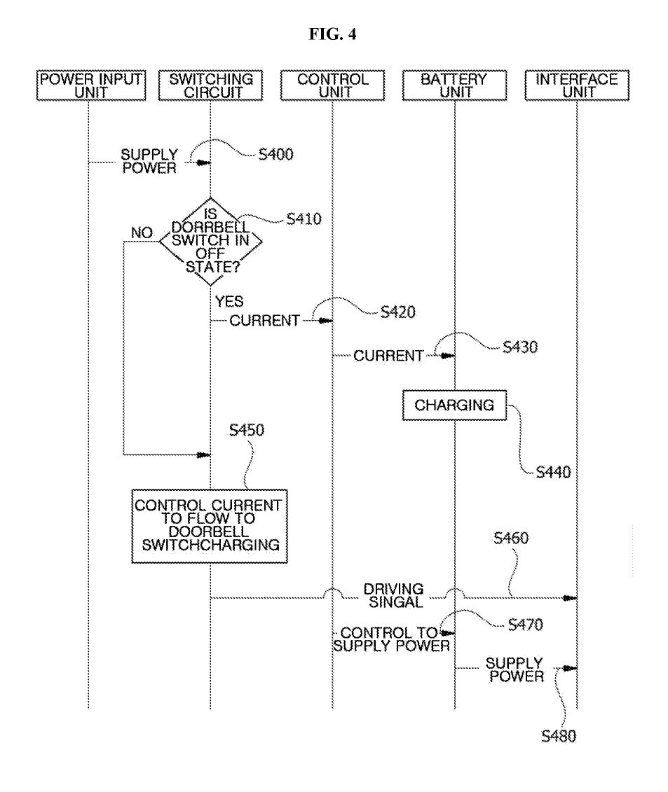

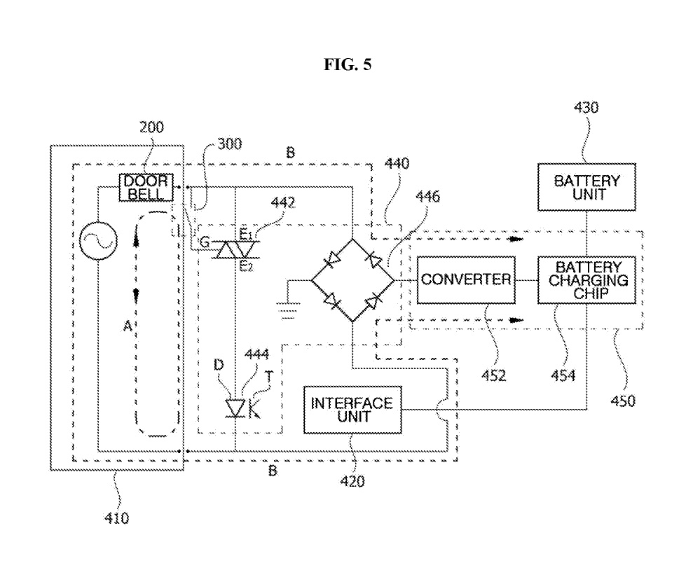

FIG. 2 is a block diagram of a doorbell device according to one embodiment of the present invention, FIG. 3 is a block diagram of an interface unit included in the doorbell device according to one embodiment of the present invention, and FIG. 4 is a flowchart illustrating a method for supplying power to the doorbell device according to one embodiment of the present invention.

Referring to FIG. 2, the doorbell device 400 includes a power input unit 410, an interface unit 420, a battery unit 430, a switching circuit 440, and a control unit 450.

The power input unit 410 supplies power to the doorbell device 400. At this point, the power supplied from the power input unit 410 may be an AC voltage input from an AC power source within a house. The power input unit 410 is illustrated as being included in the doorbell device 400, but the present invention is not necessarily limited thereto. The power input unit 410 may be an external configuration of the doorbell device 400.

The switching circuit 440 is connected to the doorbell switch 300 and changes a path of a current supplied from the power input unit 410 according to the ON or OFF state of the doorbell switch 300.

The control unit 450 charges the battery unit 430 using a current output from the switching circuit 440. Further, the control unit 450 controls a supply of power to the interface unit 420.

The battery unit 430 supplies power to the interface unit 420.

Referring to FIG. 3, the interface unit 420 may include a system on chip (SoC) 421, an image module 422, a sensor module 423, an audio module 424, and a communication module 425. However, this is merely an example, and the interface unit 420 according to one embodiment of the present invention may include more or fewer configurations than these configurations.

The SoC 421 may be connected to the image module 422, the sensor module 423, the audio module 424, and the communication module 425 and may control the entire interface unit 420.

The image module 422 may be interchangeably used with a camera module. The image module 422 may include a lens and an image sensor. The lens includes at least one among a convex lens, a concave lens, a cylindrical lens, a Fresnel lens, and a wide-angle lens and is configured to photograph a target object which is positioned within a predetermined range from an installation position of the lens. The image sensor converts an optical signal incident through a lens module into an image signal. The image sensor corresponds to a component which is generally employed in a digital camera and the like and serves to convert light incident through a camera lens, i.e., photographed image information, into digital information, which is an electrical signal.

The sensor module 423 senses a surrounding target object. For example, the sensor module 423 may include at least one of a geomagnetic sensor, an acceleration sensor, an altimeter, a gyro sensor, and an infrared sensor. Here, the infrared sensor may be a passive infrared ray (PIR) sensor. The PIR sensor may sense a temperature variation of a target object. Therefore, when a person moves, the sensor module 423 may sense that the person exists through utilizing the temperature variation. A plurality of sensor modules 423 may be installed at the periphery of the image module 422.

The SoC 421 receives an image signal through the image module 422 and a sensing signal with respect to a target object through the sensor module 423 to process the received image signal and the received sensing signal. For example, the SoC 421 may compensate for the image signal received through the image module 422 using the sensing signal, which is received through the sensor module 423, with respect to the target object.

Meanwhile, the audio module 424 may include a microphone and a speaker. The microphone may receive an audio signal, and the speaker may output the audio signal. The SoC 421 may process the audio signal which is input through the microphone.

The communication module 425 includes a wired or wireless communication module and may transmit the image signal, which is processed through the SoC 421, to a display device (not shown) or the audio signal, which is processed through the SoC 421, to the speaker.

According to the embodiment of the present invention, the interface unit 420 may be operated in a sleep mode or an operation mode. When the interface unit 420 is operated in the operation mode, power consumption is higher than power consumption when the interface unit 420 is operated in the sleep mode.

When the doorbell switch 300 is in an ON state, the interface unit 420 may be switched from the sleep mode to the operation mode by a driving signal transmitted in response to a current flowing toward the doorbell switch 300.

Referring to FIGS. 2 and 4, the switching circuit 440 receives power from the power input unit 410 (S400). The power input unit 410 may supply an AC voltage input from an AC power source within a house to an interior of the doorbell device 400. In the present disclosure, the power input unit 410 supplies power to the interior of the doorbell device 400, and thus the power input unit 410 may be referred to as a power supply unit. The switching circuit 440 is connected to the doorbell switch 300 and changes a path of a current supplied from the power input unit 410 according to the ON or OFF state of the doorbell switch 300.

That is, when the doorbell switch 300 is in the OFF state, the switching circuit 440 may control the path of the current to be directed toward the battery unit 430 through the control unit 450 (S410). Accordingly, the current is output toward the control unit 450 (S420), flows to the battery unit 430 (S430), and charges the battery unit 430 (S440).

Meanwhile, when the doorbell switch 300 is in the ON state, the switching circuit 440 controls the path of the current to be directed toward the doorbell 200 and the doorbell switch 300 (S450). At this point, a driving signal may be transmitted to the interface unit 420 in response to a current flowing to the doorbell switch 300 (S460).

Meanwhile, when the doorbell switch 300 becomes the ON state and thus a current flows to the doorbell switch 300, the path through which the current flows toward the control unit 450 is cut off. At this point, the control unit 450 may control the battery unit 430 to supply power to the interface unit 420 (S470). Accordingly, the battery unit 430 may supply the charged power to the interface unit 420 (S480).

As described above, even when the doorbell switch 300 is in the ON state, the power may be stably supplied to the interface unit 420.

Hereinafter, the doorbell device according to one embodiment of the present invention will be described in more detail with reference to a circuit diagram.

FIG. 5 is a circuit diagram included in the doorbell device according to one embodiment of the present invention.

Referring to FIG. 5, an AC power is supplied to the doorbell device 400 through the power input unit 410.

The switching circuit 440 is connected to the doorbell switch 300 and includes a triac element 442. The triac element 442 is a semiconductor control element for performing bi-directional current control and has two main electrodes E1 and E2 and one gate electrode G. When a gate signal is not applied to the gate electrode G, the triac element 442 may be turned off, and when the gate signal is applied to the gate electrode G, the triac element 442 may be bi-directionally connected regardless of polarities of the main electrodes E1 and E2.

When the doorbell switch 300 is pressed, i.e., when the doorbell switch 300 becomes an ON state, the gate signal is applied to the gate electrode G of the triac element 442, and thus a closed circuit is formed as Path A. That is, a path of a current is directed to the doorbell 200 and the doorbell switch 300, and the current may be cut off so as not to flow in Path B toward the control unit 450.

Here, the doorbell 200 and the power input unit 410 including the doorbell 200 are exemplified as being included in the doorbell device 400 according to one embodiment of the present invention, but the present invention is not limited thereto. The doorbell 200 and the power input unit 410 including the doorbell 200 may not be included in the doorbell device 400 according to one embodiment of the present invention. Consequently, the doorbell device 400 according to one embodiment of the present invention may be interchangeably used with the doorbell 200 installed within a house in advance and the power input unit 410 including the doorbell 200.

Meanwhile, the switching circuit 440 further includes a gate element 444. The gate element 444 is connected to the triac element 442 and is operated in response to a current flowing to the doorbell 200 and the doorbell switch 300 when the triac element 442 is turned on. Further, the gate element 444 may transmit a driving signal to the interface unit 420 in response to the current flowing to the doorbell 200 and the doorbell switch 300. To this end, the gate element 444 may include an optocoupler. The optocoupler may be interchangeably used with a photo coupler. The optocoupler includes a light emitting diode D and a phototransistor T, and when a current is applied to the light emitting diode D, the light emitting diode D emits light. The phototransistor T may receive light emitted by a light emitting diode D to become a conducting state. Using such a principle, when the doorbell switch 300 is pressed, i.e., when the doorbell switch 300 is turned on, the triac element 442 is turned on and thus the gate element 444 may transmit a signal for driving the interface unit 420 to the interface unit 420.

Meanwhile, when the doorbell switch 300 is released from the pressed state, i.e., when the doorbell switch 300 becomes an OFF state, a path of the current is directed to the control unit 450. To this end, the switching circuit 440 may further include a rectifier 446. The rectifier 446 is connected to the control unit 450 and rectifies an AC current supplied from the power input unit 410 into a direct current (DC) current to supply the DC current to the control unit 450. For example, the rectifier 446 may include a bridge diode. As shown in FIG. 5, the bridge diode is a bridge circuit in which four diodes are connected. The bridge diode rectifies the AC current into the DC current to output the DC current, and a voltage input to the bridge diode is equal to a voltage output therefrom.

The control unit 450 receives the DC current rectified by the rectifier 446. The control unit 450 may include a converter 452 and a battery charging chip 454. The converter 452 may drop a voltage of the DC current output through the rectifier 446 to a voltage suitable for the battery charging chip 454. Here, the converter 452 may be a DC-DC converter. For example, the converter 452 may convert a voltage in the range of 8 to 24V into a voltage of 5V.

The battery charging chip 454 is connected to the converter 452 and receives a predetermined voltage from the converter 452. The battery charging chip 454 may control to allow power to be supplied to the interface unit 420 or may control the battery unit 430 to be charged with the power. The battery charging chip 454 may control the battery unit 430 to supply the power charged in the battery unit 430 to the interface unit 420.

For example, when the doorbell switch 300 is in the OFF state, power cannot be supplied to the interface unit 420 through the switching circuit 440. At this point, the battery charging chip 454 may control the voltage, which is rectified by the rectifier 446 and then converted by the converter 452, to also be applied to the interface unit 420, or the battery charging chip 454 may control the power charged in the battery unit 430 to be supplied to the interface unit 420.

Further, when the doorbell switch 300 is in an ON state, the driving signal may be transmitted to the interface unit 420 through the switching circuit 440, but power may be insufficient in allowing the interface unit 420 to continue the operation. Accordingly, when the doorbell switch 300 is in the ON state and a path of a current output to the control unit 450 is blocked, the control unit 450 may control the battery unit 430 to supply the power charged in the battery unit 430 to the interface unit 420.

Consequently, the interface unit 420 may stably receive the power regardless of the ON or OFF state of the doorbell switch 300. Further, even in an instance when the doorbell switch 300 is switched from the ON state to the OFF state, the power charged in the battery unit 430 may be supplied to the interface unit 420, so that operation quality of the interface unit 420 can be improved.

In the present disclosure, the doorbell and the doorbell switch which are installed within a house in advance are exemplified and described, but the present invention is not limited thereto. At least one of the doorbell and the doorbell switch may be included in the doorbell device according to one embodiment of the present invention.

As has been described above, while the description has been made with reference to the preferred embodiments of the present invention, it should be understood that various alternations and modifications of the present invention can be devised by those skilled in the art within a range not departing from the spirit and scope of the present invention, which are defined by the appended claims.

### DESCRIPTION OF REFERENCE NUMERALS

400: doorbell device

410: power input unit

420: interface unit

430: battery unit

440: switching circuit

450: control unit

1. A doorbell device comprising:
a power input unit;
an interface unit;
a battery unit for supplying power to the interface unit;
a switching circuit connected to a doorbell switch and configured to change a path of a current supplied from the power input unit according to an ON or OFF state of the doorbell switch; and
a control unit for charging the battery unit using a current output from the switching circuit,
wherein, when the current output from the switching circuit toward the control unit is cut off, the control unit controls the battery unit to supply power to the interface unit.

2. The doorbell device of claim 1, wherein the path of the current is a path directed from the power input unit to the control unit or is a path directed from the power input unit to the doorbell switch.

3. The doorbell device of claim 2, wherein:
the switching circuit includes a triac element, and
when the doorbell switch is turned on, the triac element cuts off a current output to the control unit and allows the current to flow to the doorbell switch.

4. The doorbell device of claim 3, wherein the switching circuit further includes a gate element, and the gate element transmits a driving signal to the interface unit.

5. The doorbell device of claim 4, wherein the gate element is connected to the triac element and is operated in response to the current flowing to the doorbell switch.

6. The doorbell device of claim 4, wherein the gate element includes an optocoupler.

7. The doorbell device of claim 1, wherein:
the switching circuit further includes a rectifier, and
the rectifier rectifies an alternating current (AC) current, which is a current received from the power input unit, into a direct current (DC) current and supplies the DC current to the control unit.

8. The doorbell device of claim 7, wherein the rectifier includes a bridge diode.

9. The doorbell device of claim 1, wherein the interface unit includes at least one of an audio module, an image module, a communication module, and a sensor module.

10. The doorbell device of claim 1, wherein the control unit includes a converter and a battery charging chip.

11. A method for supplying power to doorbell device, comprising:
receiving, by a switching circuit, power from a power input unit;
changing, by the switching circuit, a path of a current supplied from the power input unit according to an ON or OFF state of a doorbell switch;
charging, by a control unit, a battery unit using a current output from the switching circuit;
when the current output from the switching circuit is cut off, controlling, by the control unit, the battery unit to supply power to an interface unit; and
supplying, by the battery unit, charged power to the interface unit.

12. The method of claim 11, wherein the changing of the path of the current includes blocking the path of the current output to the control unit and allowing the current to flow toward the doorbell switch when the doorbell switch is in the ON state, and allowing the current to flow to the control unit when the doorbell switch is in the OFF state.

13. The method of claim 12, further comprising, when the doorbell switch is in the ON state, transmitting a driving signal to the interface unit in response to a current flowing to the doorbell switch.

14. The method of claim 13, wherein:
the switching circuit includes a triac element, and
the method further includes:
when the doorbell switch is in the ON state, applying a gate signal to a gate electrode of the triac element; and
turning on the triac element.

15. The method of claim 14, wherein:
the switching circuit further includes a gate element, and
when the triac element is turned on, the method further includes transmitting, by the gate element, the driving signal to the interface unit.
